(19) United States
(12) Patent Application Publication
(10) Pub. No.: US 2003/0209873 A1
(43) Pub. Date: Nov. 13, 2003

(54) Wheelchair

(75) Inventor: David Oliver Batty, Coventry (GB)

Correspondence Address: SUGHRUE MION, PLLC, 1010 EL CAMINO REAL, SUITE 300, MENLO PARK, CA, 94025, US

(73) Assignee: REMPLOY LIMITED, Coventry (GB)

(21) Appl. No.: 10/431,919

(22) Filed: May 7, 2003

(30) Foreign Application Priority Data
May 8, 2002 (GB) 0210532.8

(51) Int. Cl. B62B 9/00

(52) U.S. Cl. 280/250.1; 280/47.38

(57) ABSTRACT

Wheelchairs typically have a pair of side frames consisting of upright tubular members at the front and back joined by tubular top and bottom rails. Castor type wheels are swivellably mounted at the lower end of the front upright members and the rear upright members are usually connected directly or indirectly to rear wheels of the wheelchair. A joint at the bottom front corner of the side frame comprises a moulded connector having a generally tubular portion which fits over the end of the upright and includes a projecting spigot which fits inside the lower tubular rail. The connector includes a reinforcing web extending between the top of the spigot and the tubular portion and a lower supporting lug. The end of the rail is shaped to fit around and embrace the reinforcing web and the supporting lug.

### BACKGROUND OF THE INVENTION

Wheelchairs typically have a pair of side frames consisting of upright tubular members at the front and back joined by tubular top and bottom rails. The lower end of the front upright members typically have a castor type wheel swivellably mounted at their lower end and the rear upright members are usually connected directly or indirectly to the rear wheels of the wheelchair. The rear wheels may be relatively small for a wheelchair that is always be pushed by an attendant or relatively large when the occupant is capable of propelling themself. The two side frames are connected together by cross-members pivoted in the form of a X or having the form of over-centre toggle linkages. In this way the cross-members connect the side frames together to form a rigid three-dimensional frame of the wheelchair, but the configuration of the cross-members can be changed to allow the wheelchair to be collapsed by moving the two side frames close together.

In a static position on a horizontal surface each of the two front castors support approximately 20% of the total chair and occupant weight. When the wheelchair is moving over an uneven surface the loading can fluctuate between each castor with up to 40% of the total weight being intermittently supported on each castor. Additionally, uneven ground can exert loads on the castor in both horizontal directions which must be accommodated by the frame. Further, one has to take account of the effect of slopes and kerb drops which are in many user environments. Thus, there are frequent occasions when the whole weight of the wheelchair and occupant is supported on a single front castor. The dynamic effect of this complex loading into the castor area in several directions results in a combination of shear and torque loading which must be accommodated in the design.

Traditionally the lower front corner of a side frame of a wheelchair is therefore structurally reinforced by supporting brackets or other features to resist the various input loads. This strengthening increases the weight of the wheelchair, affects the appearance, and usually leads to the lower front corner of the side frame of the wheelchair being welded since this is the only way in which sufficient strength and resilience can be achieved. In many cases damage to this area of the wheelchair to any of the parts that are welded together, results in the total chair being scrapped since it is uneconomic to attempt to repair or replace such welded portions.

Assembled wheelchairs are bulky even in their collapsed state. Accordingly, it would be desirable to supply wheelchairs in kit-form since this would simplify the initial transport from the factory to a supply and distribution centre and this is especially true where the wheelchairs are manufactured in one country for use in another.

### SUMMARY OF THE INVENTION

According to this invention a wheelchair includes a joint at the bottom front corner of its side frame between a front upright and a lower tubular rail comprising a moulded connector having a generally tubular portion which fits over the end of the upright and includes a projecting spigot which fits inside the lower tubular rail, the connector including a reinforcing web extending between the top of the spigot and the tubular portion and a lower supporting lug, the end of the rail being shaped to fit around and embrace the reinforcing web and the supporting lug.

Preferably, the connector is injection moulded from a plastics material, although it could also be die-cast. Preferably, the connector is moulded from glass reinforced nylon.

Preferably, a fitting locating a castor inside the lower end of the front upright member of the side frame is located wholly within the generally tubular portion of the connector and a fixing joining the connector to the front tubular member also passes through the fitting and so directly joins the fitting, the front upright member and the connector together. Preferably, the connector is joined to both the upright tubular member and the rail member by screw threaded fasteners. The fixing between the lower rail and the spigot may also comprise a fixing point for the front cross-member joining the two side frames together.

Preferably, the connector also includes a reinforcing web extending between the bottom of the spigot or the lower supporting lug and the tubular portion.

With the connector in accordance with this invention and, in particular with the formation of the end of the lower tubular rail so that it is shaped to fit around and embrace the reinforcing web and the supporting lug, the length of contact between the end edge of the lower rail and the connector is increased so arranged to absorb and distribute dynamic input loads and stresses of the castor in both the vertical and sideways direction into the wheelchair side frame. This connector portion thus enables the entire framework of the wheelchair to be provided in a knockdown or kit form and for a wheelchair to be assembled without the need for any welding. It also enables any damage to the front upright member, lower rail or connector to be repaired quickly by a simple service replacement operation without the need to scrap the complete wheelchair.

### BRIEF DESCRIPTION OF THE DRAWINGS

A particular example of a wheelchair in accordance with this invention will now be described with reference to the accompanying drawings; in which:—

FIG. 1 is a perspective view of a wheelchair from the front and right hand side;

FIG. 2 is a scrap side elevation of the assembled lower front corner of the side frame;

FIG. 3 is a perspective view of a connector for the lower front corner of a wheelchair viewed from above and the left hand side;

FIG. 4 is a perspective view of the connector from below and the right hand side; and,

FIG. 5 is a vertical section through the connector.

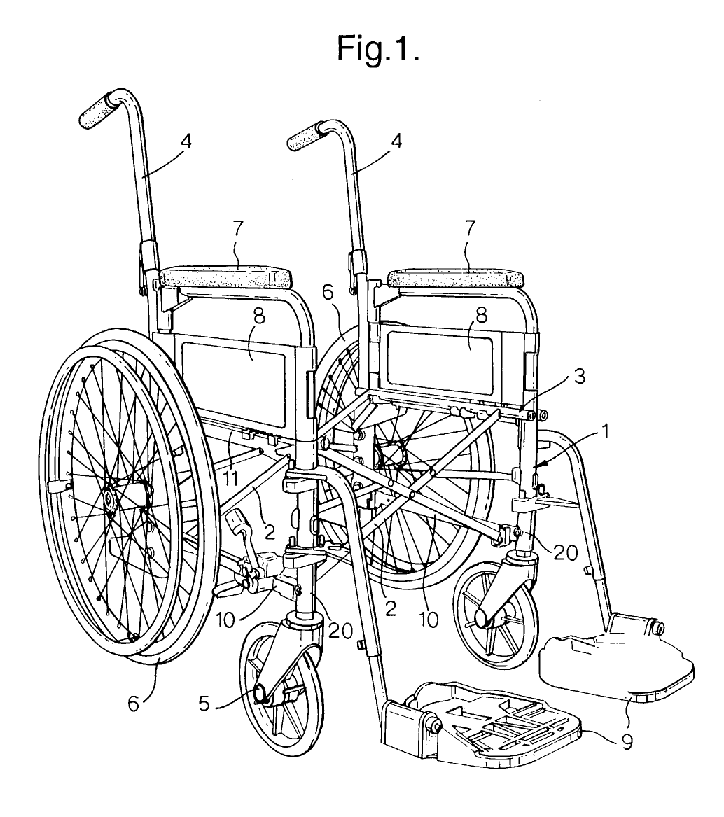

### DESCRIPTION OF PREFERRED EXAMPLE

This example of a wheelchair includes a framework formed by two side frames 1 joined together by front and back cross-members 2 which are pivoted together in the form of a X and the upper ends of which are connected to rails 3 which, in use, support a seat (omitted for clarity). Folding handles 4 are connected to the side frames 1 and support a seat back (omitted for clarity). Front castor wheels 5 are attached to the lower front corner of the side frames 1 and larger wheels 6 are connected to the rear of the side frames 1. Armrest frames 7 including infill panels 8 are fitted into the top of the side frames 1 and footrests 9 are connected to the front of each of the side frames 1.

Each side frame 1 includes front and rear upright tubular members and generally horizontal rails 10 and 11. The upright members and generally horizontal rails 10 and 11 are joined together by connectors.

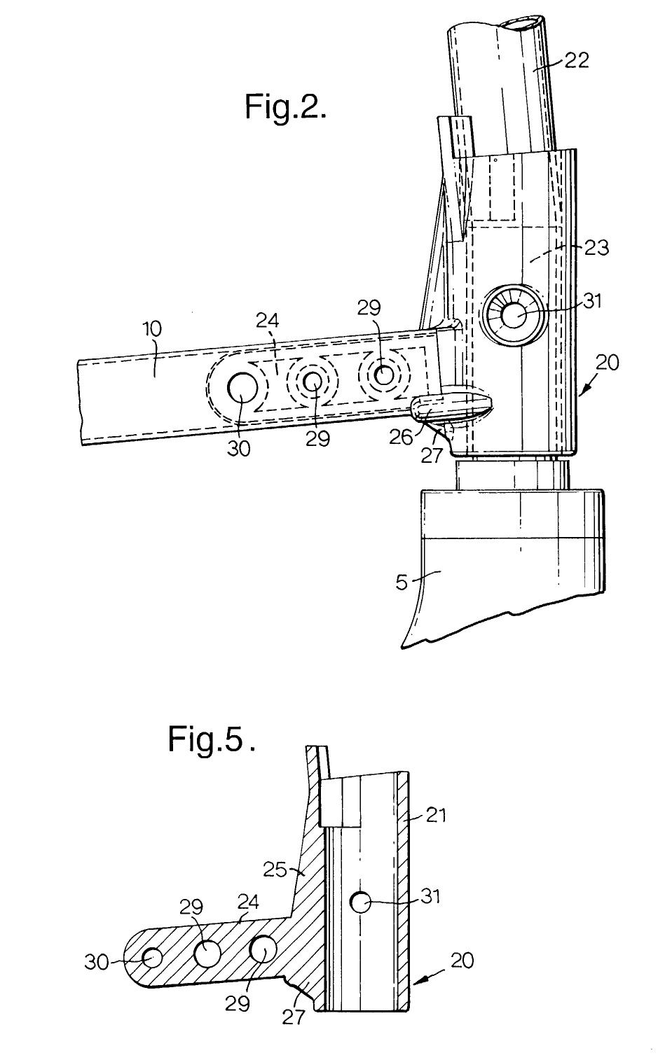

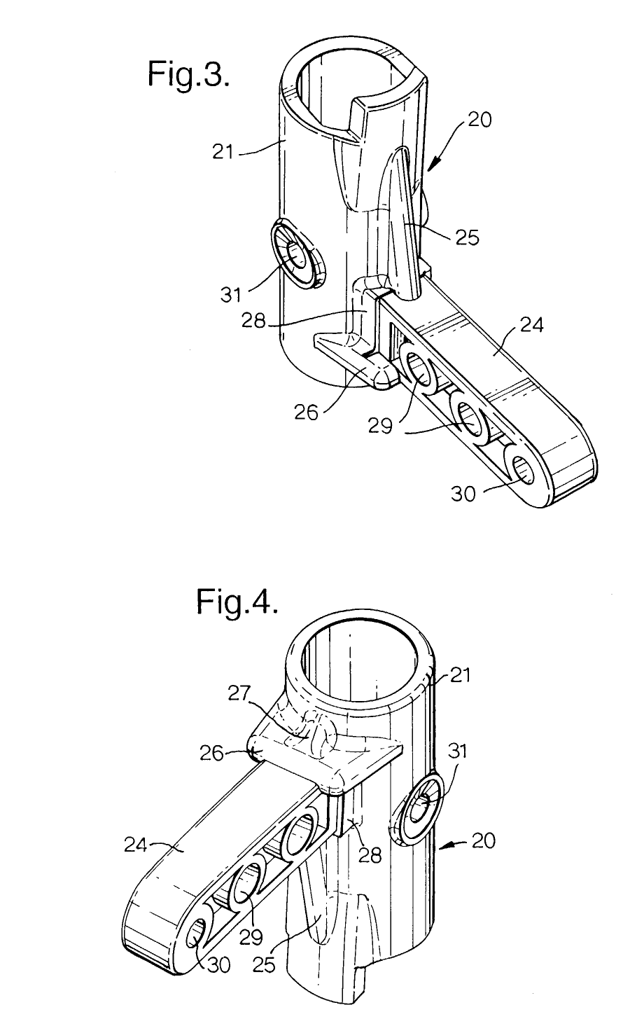

The connector 20 at the lower front corner comprises a tubular portion 21 which fits snugly over the outside of the front upright tube 22 (shown in FIG. 2) forming the front upright tube of the side frame 1. The tube 22 includes a crank of about 5° so that the swivel axis of the castor 5 and hence the tubular portion 21 of the connector 20 is vertical whilst the remainder of the tube 22 and the tubular rails 10 and 11 are inclined at about 5° to the vertical or horizontal, respectively. A peg 23 forming the connecting fitting of the swivellable castor 5 is inserted inside the lower portion of the tubular upright member 22 and lies substantially wholly within the tubular portion 21 of the connector 20.

As shown in FIG. 2 the connector 20 also includes a spigot 24 which has a rectangular cross-section which fits snugly inside the rectangular cross-section generally horizontal rail 10. The connector 20 is injection moulded from glass reinforced nylon and includes an integrally moulded reinforcing web 25 extending between the tubular portion 21 and the top of the projecting spigot 24, a support lug 26 which acts to buttress the spigot 24 in the horizontal plane, and a lower reinforcing web 27. The reinforcing webs 25 and 27 buttress the spigot 24 in the vertical plane and the junction between the spigot 24 and tubular portion 21 is formed with a generally rectangular boss 28 which forms an abutment for the front end of the rail 10 and has an outer profile which matches that of the rail 10.

The spigot 24 includes holes 29 and 30 and the tubular portion includes a hole 31. Corresponding holes are provided in the rail 10, tubular member 22 and peg 23 to enable bolts to be passed through the holes 29 into brackets pivotably connected to the lower ends of the cross-members 2. A nut and bolt fastening also passes through the holes 31 to connect together the peg 23 of the castor 5, the tubular member 22 and the tubular portion 21 of the connector 20. Finally, a self-tapping screw is inserted into the hole 30 to fix the spigot 24 to the rail 10. The leading end of the rail 10 is shaped to fit around the reinforcing web 25 and the supporting lug 26 and, otherwise, abuts against the boss 28. The webs 25 and 27 and supporting lug 26 buttress the spigot in both horizontal and vertical planes and the cut-out formation on the end of the rail 10 ensures that the end edge of the rail 10 conforms with the connector 20 over an elongate length which serves to spread the up and down, sideways and torsional impact loads generated by the castor 5 moving across the ground to the side frame 1.

I claim:—

1. In a wheelchair including a joint at the bottom front corner of its side frame between a lower end of a front upright and a lower tubular rail, the improvement comprising a moulded connector, said moulded connector having a generally tubular portion and a projecting spigot, said generally tubular portion fitting over said lower end of said front upright, said projecting spigot fitting inside said lower tubular rail, said moulded connector also including a reinforcing web extending between said spigot and said tubular portion and a supporting lug, said rail being shaped to fit around and embrace said reinforcing web and the supporting lug.

2. A wheelchair according to claim 1, wherein said connector is injection moulded from a plastics material.

3. A wheelchair according to claim 2, wherein said connector is moulded from glass reinforced nylon.

4. A wheelchair according to claim 1, wherein said wheelchair also includes a castor mounted to said bottom front corner of said side frame, a fitting mounting said castor being located inside said lower end of said front upright member of said side frame and being located wholly within said generally tubular portion of said connector, a fixing joining said connector to said front tubular member also passing through said fitting and so directly joining said fitting, said front upright member and said connector together.

5. A wheelchair according to claim 1, wherein said connector is joined to both said upright tubular member and said rail by screw threaded fasteners.

6. A wheelchair according to claim 4, wherein said connector is joined to both said upright tubular member and said rail by screw threaded fasteners.

7. A wheelchair according to claim 1, wherein said connector also includes a reinforcing web extending between said tubular portion and one of said spigot and said supporting lug.

8. A wheelchair according to claim 1, which further includes a front cross-member joining two side frames together, said tubular rail and said spigot including attachment means for joining said front cross-member to said side frame.

9. A wheelchair according to claim 4, which further includes a front cross-member joining two side frames together, said tubular rail and said spigot including attachment means for joining said front cross-member to said side frame.
